(19) United States
(12) Patent Application Publication
(10) Pub. No.: US 2008/0091409 A1
(43) Pub. Date: Apr. 17, 2008

(54) Customizable mathematic expression parser and evaluator

(75) Inventor: Matthew Douglas Anderson, Littleton, CO (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/581,546

(22) Filed: Oct. 16, 2006

(51) Int. Cl. G06F 17/27

(52) U.S. Cl. 704/9

(57) ABSTRACT

A customizable, portable, object-oriented expression parser and evaluator provides the ability to customize syntactic and semantic elements of expression parsing and evaluation via class inheritance and interface implementation. The customizable expression parser/evaluator provides independence from a fixed variable resolution process, provides flexibility in the data types used for representing numbers and other values, and provides notifications that allow inspection and validation during expression parsing and evaluation. The customizable expression parser/evaluator utilizes a class library that supports mathematical expression parsing according to rules that can be customized by developers using object orientated programming. The customizable expression parser/evaluator class library provides a set of classes to parse and evaluate mathematical and logical expressions. The class library supports the evaluation of expressions having varying degrees of complexity.

### TECHNICAL FIELD

The technical field is generally related to computer processing and more specifically relates to parsing and evaluating expressions.

### BACKGROUND

The ability to parse and evaluate complex, user-defined mathematical expressions is an important component of many applications. Parsing is the process of analyzing an expression to determine its grammatical structure. A parser transforms the expression into a data structure that captures the hierarchy of the expression and is suitable for subsequent processing. Existing expression parsers tend not to have the feature set and extensibility capabilities that are needed to ensure calculation functions and behavior are relevant to a particular problem domain. For example, to obtain the types of features and extensibility characteristics needed by many applications, a programmer, or the like, must undertake the difficult and tedious tasks of custom language design, development, and implementation, or embed support for an existing language execution environment within the product hosting the application. Custom language development is difficult and embedded languages typically have high educational requirements for users. That is, an end user would be required to be much more knowledgeable about the language syntax and execution environment than would be desired for an application targeted at non-technical users. In addition, embedded languages may offer features and capabilities that could lead to unintended and possibly malicious use of the software.

### SUMMARY

This Summary is provided to introduce a selection of concepts in a simplified form that are further described below in the Detailed Description Of Illustrative Embodiments. This Summary is not intended to identify key features or essential features of the claimed subject matter, nor is it intended to be used to limit the scope of the claimed subject matter.

A customizable, portable, object-oriented expression parser and evaluator provide robust expression parsing and evaluation without requiring custom language development and without requiring the embedding of an existing language interpreter into the processing environment. The customizable expression parser/evaluator utilizes a base class that provides for easy customization of parameters, flexible data types, and no need for code generation. The customizable expression parser/evaluator is modular such that is can be ported across applications. The customizable expression parser/evaluator provides many customizable features as well. For example, it provides customizable number formats, scale, rounding, and operators, including symbol, precedence, arity, and associativity. The customizable expression parser/evaluator provides customizable variable format and resolution, accepting variable values from any appropriate source. Also provided are customizable functions including name, format, and behavior. The customizable expression parser/evaluator further provides customizable complex expressions comprising multiple keywords (e.g., if/then statements), a customizable expression tokenization process, and customizable semantic validation. The customizable expression parser/evaluator provides separation of expression parsing and evaluation, allowing an expression to be parsed once and evaluated many times. The customizable expression parser/evaluator enables syntax checking without the need for variable resolution, and provides serialization and deserialization of parsed expressions. The customizable expression parser/evaluator provides location independence, such that the customizable expression parser/evaluator is suitable for both client and server side use. Further the customizable expression parser/evaluator is localizable, in that it can be localized for use with multiple locales.

### BRIEF DESCRIPTION OF THE DRAWINGS

The foregoing summary, as well as the following detailed description, is better understood when read in conjunction with the appended drawings. For the purpose of illustrating a customizable mathematic expression parser and evaluator, there is shown in the drawings exemplary constructions thereof; however, the customizable mathematic expression parser and evaluator is not limited to the specific methods and instrumentalities disclosed.

FIG. 1 is a depiction of an example class library for the customizable expression parser/evaluator.

FIG. 2 shows a table depicting example mathematical and logical expressions that can be evaluated by the customizable expression parser/evaluator.

FIG. 3 shows a table depicting example mathematical functions that can be evaluated by the customizable expression parser/evaluator.

FIG. 4 is a continuation of FIG. 3.

FIG. 5 is a flow diagram of an example process for parsing and evaluating an expression utilizing the customizable expression parser/evaluator.

FIG. 6 is a diagram of an example parse tree.

FIG. 7 is a diagram of another example parse tree.

FIG. 8 depicts example pseudo code for an example process for parsing an expression.

FIG. 9 is a continuation of FIG. 8.

FIG. 10 is a sequence flow diagram of an example process for evaluating a parse tree.

FIG. 11 is a flow diagram of an example process for adding a new binary operator.

FIG. 12 is a flow diagram of an example process for adding a new grouping operator.

FIG. 13 is a flow diagram of an example process for adding a new function.

FIG. 14 is a flow diagram of an example process for adding custom serialization formats.

FIG. 15 depicts an example computing environment in which the customizable expression parse/evaluator can be implemented.

### DETAILED DESCRIPTION OF ILLUSTRATIVE EMBODIMENTS

The customizable expression parser/evaluator provides the ability to customize syntactic and semantic elements of expression parsing and evaluation via class inheritance and interface implementation. The customizable expression parser/evaluator provides independence from a fixed variable resolution process, provides flexibility in the data types used for representing numbers and other values, and provides notifications (events) that allow inspection and validation during expression parsing and evaluation.

The customizable expression parser/evaluator utilizes a class library that supports mathematical expression parsing according to rules that can be customized, or modified, by developers, or the like, using object orientated programming. The customizable expression parser/evaluator class library provides a set of classes to parse and evaluate mathematical and logical expressions. The class library supports the evaluation of expressions having varying degrees of complexity. For example, the customizable expression parser/evaluator supports: the evaluation of whole and fractional numbers, both positive and negative (e.g., −5.23), the evaluation of operators according to standard precedence rules (e.g., 5+3/2*4), the evaluation considering grouping precedence and any number of nested sub-expressions (e.g., (5+3)/(2*4)), the evaluation of function (e.g., the absolute value function −Abs(−5)), the evaluation of variables using custom variable resolution (e.g., 5+y), the evaluation of assignments expressions (e.g., x=5+4), and the evaluation to a Boolean result (e.g., true or false −5≧4*3).

The customizable expression parser/evaluator implements support for a simple IF-THEN-ELSE statement; however, subclasses can define the supported set of complex expressions for a specific implementation, if any. In an example embodiment, default expression tokenization processing supports the desired calculation parsing functionality, and, additional, custom requirements for expression tokenization can be implemented by replacing the default tokenizer. The class library also supports the definition and evaluation of custom complex expressions, which can include syntax not specifically identified as mathematical or logical. For example, the customizable expression parser/evaluator supports expressions of the following form.

IF<Boolean-expression>THEN<math-expression>ELSE<math-expression>

### The class library supports extensibility in terms of expression syntax, operators/operations, precedence and associativity rules, functions, variable resolution, number precision and scale, culture awareness, case sensitivity, and data types.

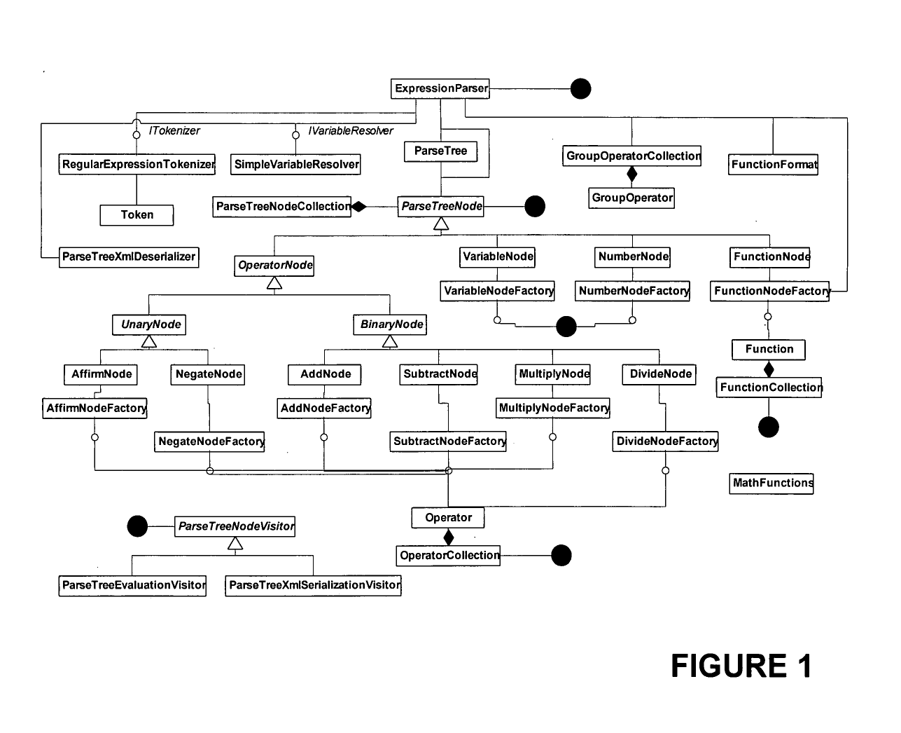

FIG. 1 is a depiction of an example class library for the customizable expression parser/evaluator. A subset of the classes and interfaces of the customizable expression parser/evaluator are shown FIG. 1, along with an indication of interrelationships between the classes. In an example embodiment, the customizable expression parser/evaluator comprises greater than 60 classes within the class library. The class library comprises a main ExpressionParser class, along with other classes, interfaces, structures, enumerations, and other types that support the parsing and evaluation processes. In an example embodiment, the class library is written in C#.

Consumers of the class library interact with the ExpressionParser class for expression parsing, validation, evaluation, serialization, and deserialization, as well as for controlling aspects of the behavior of the parser, such as number scaling and rounding. More extensive customization of the parsing and evaluation behavior can occur by inheriting from the ExpressionParser class and, depending on the extent of the customization, deriving from other classes and interfaces as well.

As shown in FIG. 1, the central class in the class library is ExpressionParser, which implements support for customizable expression parsing and evaluation. During expression parsing, the ExpressionParser breaks the expression into distinct parts (via an ITokenizer implementation) and generates a parse tree to represent the order in which each operator and function in the expression should be evaluated. The Node classes are used to represent the various types of tokens that can be present within an expression. New Node classes can be created and identified to the ExpressionParser as needed by the implementation. The ParseTreeNodeVisitor class functions as a base class that allows evaluation, serialization, or other processing of the nodes in a parse tree. The MathFunctions class includes custom math functions that are not available within the .NET Framework, such as standard numeric rounding.

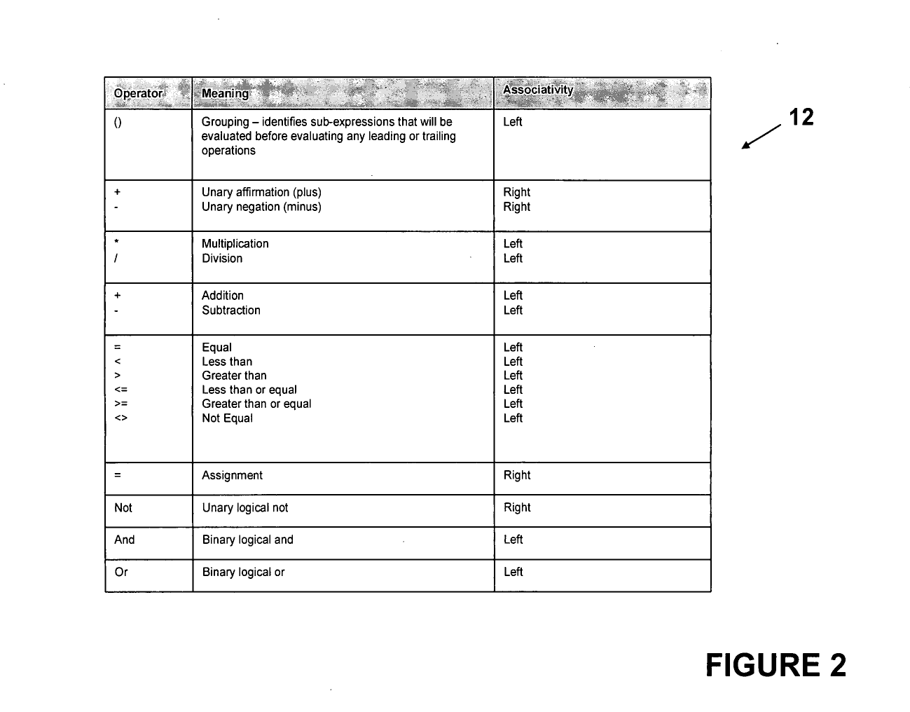

FIG. 2 shows a table 12 depicting example mathematical and logical expressions that can be evaluated by the customizable expression parser/evaluator. The class library supports a set of mathematical and number-oriented logical expressions by default. That is, expressions containing any of the operators listed in the table 12 will be evaluated according to established meaning and precedence rules. As depicted in the table 12, operators are listed by precedence, with the highest precedence operators first (top of column). Operators in the same segment (row) of the table 12 have equal precedence and are evaluated based on their associativity and relative occurrence within an expression.

The Unary affirmation operation and the binary addition operation, depicted in the table 12, utilize the same symbol (i.e., the plus symbol “+”). The behavior of the symbol is defined by the context. For example, if the character, or characters, to the left of the plus symbol are a binary operator or there is no token to the left, the plus symbol is treated as a unary affirmation operation. Otherwise, the plus symbol is treated as an addition operation. In an example embodiment, if using the same symbol for both operations is not desired or appropriate for a particular context, the symbols can be changed, as described below, by subclasses of the ExpressionParser.

The equality operation and the assignment operation use the same symbol (i.e., the equal symbol “=”). The behavior of the symbol is defined the context. In an example embodiment, the default behavior for the equal symbol is assignment if variable resolution is enabled and the left hand operand is a variable. Otherwise, the equal symbol is treated as an equality comparison operator. In another example embodiment, in the context of an IF statement, the condition evaluation for the IF statement treats the equal sign as an equality operator, even if the left hand operand is a variable. In an example embodiment, if this behavior is not desired or appropriate for a particular context, it can be changed, as described below, by subclasses of the ExpressionParser and/or the evaluation visitor used for the evaluation process.

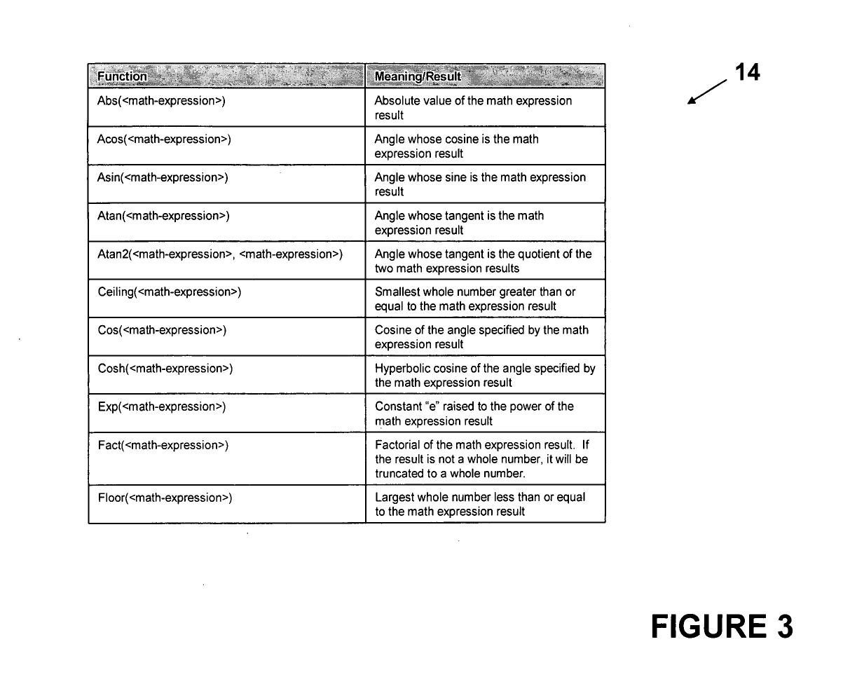

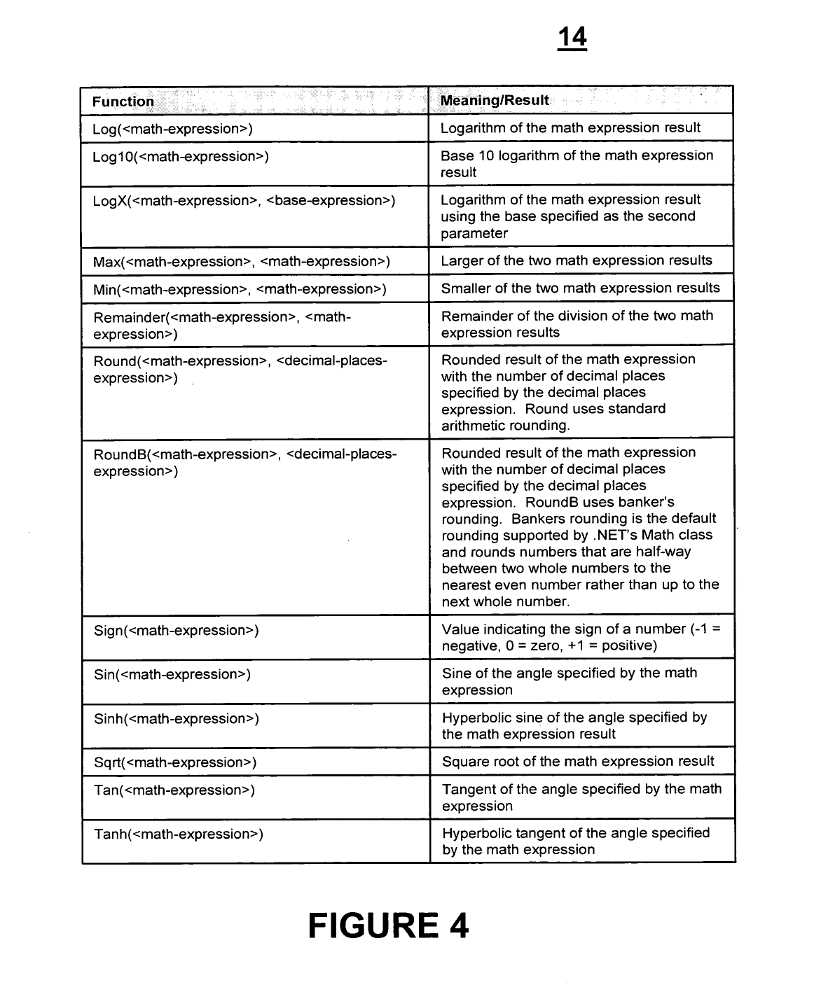

FIG. 3 and FIG. 4 show a table 14 depicting example mathematical functions that can be evaluated by the customizable expression parser/evaluator. In an example embodiment, the customizable expression parser/evaluator supports the set of math functions depicted in table 14 by default. A majority of the default functions are supported by calling static methods on the .NET Math class. For the functions not supported natively by .NET, custom function evaluation code is written.

The customizable expression parser/evaluator supports evaluation of “complex” expressions, which do not conform to standard rules for mathematical and logical expressions. That is, a complex expression comprises portions that are parsed and/or evaluated directly by the parser and those that are, from the perspective of the parser, literals that define the syntax of the expression. Those portions that are handled by the parser will be processed, and the results (whether from parsing or evaluation) are provided for subsequent processing by a specified complex expression handler function.

The parsing and evaluation processes are separate and distinct, allowing an expression to be parsed for syntactic correctness without the need for evaluation of the expression. Number interpretation is fully customizable, allowing implementers to determine what number formats will be supported by the customizable expression parser/evaluator and how those number formats should be converted to actual number values. In addition, the customizable expression parser/evaluator allows specification of any scaling and rounding that should be applied to number values either intermediately or at the completion of the evaluation process.

Variable identification and resolution are fully customizable, allowing implementers to define valid variable formats and how those variables should be resolved during expression evaluation. The customizable expression parser/evaluator's base set of unary, binary, and grouping operators are defaults, and can be expanded or completely replaced through inheritance.

Custom grouping operators are defined using the starting and ending symbols used to group sub-expressions. In an example embodiment, custom binary and unary operators are supported through the definition of the following attributes: Symbol, Precedence, Associativity, and Semantics (meaning).

In an example embodiment, the customizable expression parser/evaluator's base set of functions and function formatting are defaults, and can be expanded or replaced through inheritance. In terms of function formatting, the following example areas of customization are supported: Name format (via Regular Expression), Parameter grouping symbols, and Parameter delimiter character.

Serialization and deserialzation of parsed expressions are provided to reduce evaluation time of expressions. As is known in the art, serialization is the process of saving or transporting an object such that the object can subsequently be recreated. And, deserialization is the inverse, or opposite operation as serialization. An expression, once parsed, can be serialized to some backing store and later deserialized for use by the parser, without the need for repeated expression parsing. The serialization format(s) do not store assembly and class identification information, allowing serialized expressions to be deserialized without requiring the evaluation environment to be unchanged to that when the original serialization was performed. Additionally, external processes for serialization and deserialization of parsed expressions are supported, as long as the processes provide back to the parser a deserialized version of a parsed expression in the in-memory object graph format expected by the parser.

The customizable expression parser/evaluator is not bound to any specific data source. Rather, the customizable expression parser/evaluator allows implementers to use any location and format for data needed for calculation execution. The customizable expression parser/evaluator does not have specific environmental dependencies that prevent its use on clients or servers.

In an example embodiment, the customizable expression parser/evaluator is written in managed code, allowing direct usage from other managed code projects. In an example embodiment, the customizable expression parser/evaluator class library is written in C#.

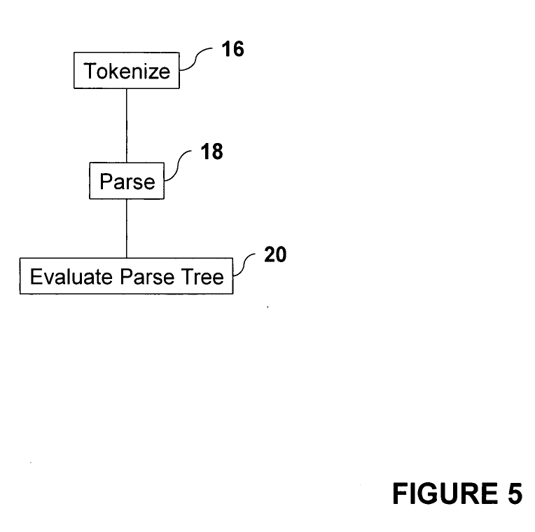

FIG. 5 is a flow diagram of an example process for parsing and evaluating an expression utilizing the customizable expression parser/evaluator. The process of evaluating an expression comprise tokenizing at step 16, parsing at step 18, and evaluating at step 20.

Tokenization (at step 16) also referred to as lexical analysis, comprises decomposing an expression into its component parts, or tokens. For example, the expression “5+4.3/3” comprises the tokens 5, +, 4.3, /, and 3. Tokenization employs an understanding of distinct symbols and groups of symbols that comprise words in an expression. In an example embodiment, tokenization is performed using a dynamically constructed regular expression pattern. The pattern defines the characteristics of “words” in parseable expressions, including operators, numbers, functions, and variables. All “non-words” are matched to allow for syntax error notification. A format for each non-word, such as functions, variables, and numbers, is defined, and that format is used by the tokenizer to decompose the expression.

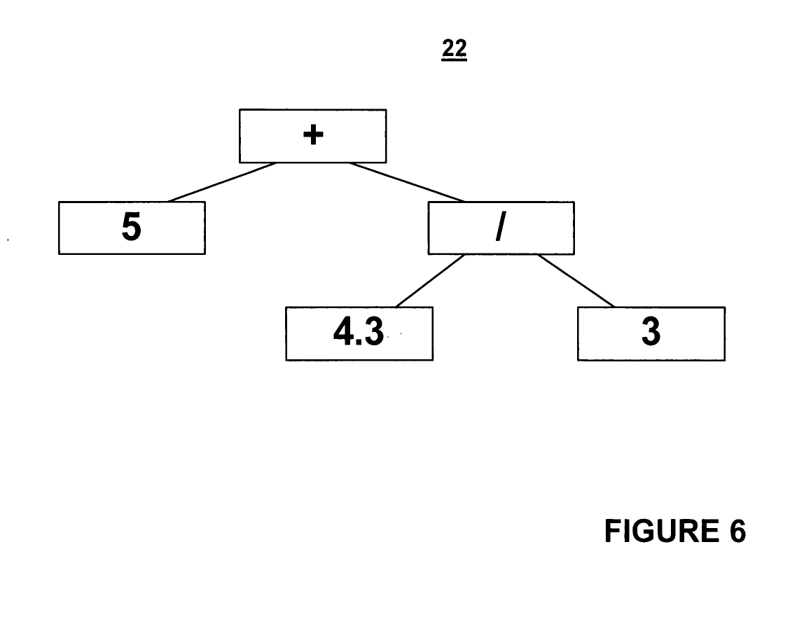

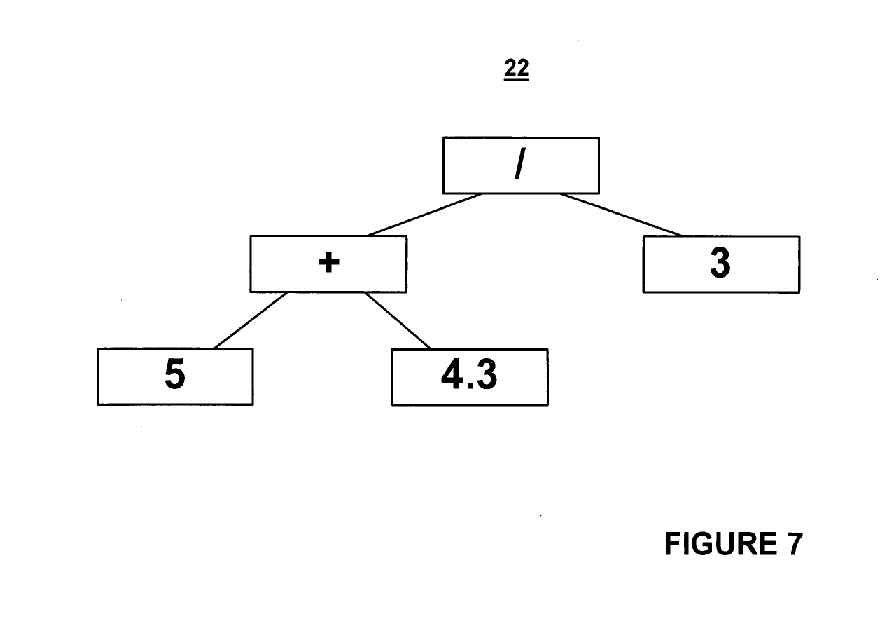

Parsing (at step 18), also referred to as syntactic analysis, comprises receiving tokens from the tokenizer (tokenized at step 16) and applying syntactic rules to the received tokens to construct a parse tree. The parse tree depicts a hierarchical structure of the tokens. FIG. 6 is a diagram of an example parse tree 22 resulting from tokenizing the expression “5+4.3/3”. The structure of the parse tree 22 dictates that the second (or right-hand) operand be evaluated before it can be added to the value 5. Accordingly, the division will take place before the addition. Adding parentheses to the expression can change the structure of the parse tree. For example, if the expression “5+4.3/3” is changed to “(5+4.3)/3”, the parse tree 22 changes to the parse tree 24 shown in FIG. 7. Accordingly, the addition operand is evaluated before the division operand.

In an example embodiment, parsing utilizes a version of recursive descent, or top-down parsing. Recursive descent makes a single pass through the tokens returned by the tokenizer and constructs the parse tree from the top to the bottom. Handler methods are defined for each token type that can be encountered in the expression. As it is implemented in the customizable expression parser/evaluator, precedence and associativity rules defined for the operators are accounted for. In an example embodiment, single token look-ahead, which is implemented by the tokenizer, is used to classify tokens.

Referring again to FIG. 5, the parse tree is evaluated at step 20. The parse tree is evaluated in accordance with the hierarchical structure of the parse tree. In an example embodiment, the parse tree is evaluated from bottom to top, left to right to obtain a result of the expression. In an example embodiment, the evaluation process is accomplished by using a visitor design pattern, in which each node in the parse tree is “visited” to obtain the result of the expression. The computations are performed within the visitor object rather than in the tree nodes themselves. This approach allows flexibility in the data types supported by each node in the parse tree, without requiring the use of the “object” type for all return values, along with the boxing and unboxing that would be required for subsequent value type computations. The use of the visitor pattern also facilitates parse tree serialization. When a parse tree is to be serialized, a visitor object visits each node in the tree to construct the serialized version of the parse tree. As a result, the nodes in the tree do not have to implement their own serialization methods, and new serialization formats can be added without changing the nodes themselves. Once a parse tree has been generated, it can be evaluated many times without regenerating the parse tree.

In an example embodiment a method is defined to handle each of the types of symbols and groups of symbols that can be used in expressions. Precedence of each operand within an expression is handled by ensuring that higher precedence operators are given the opportunity to claim operands before lower precedence operators. Same precedence operators are handled in the order defined by their associativity (either left or right).

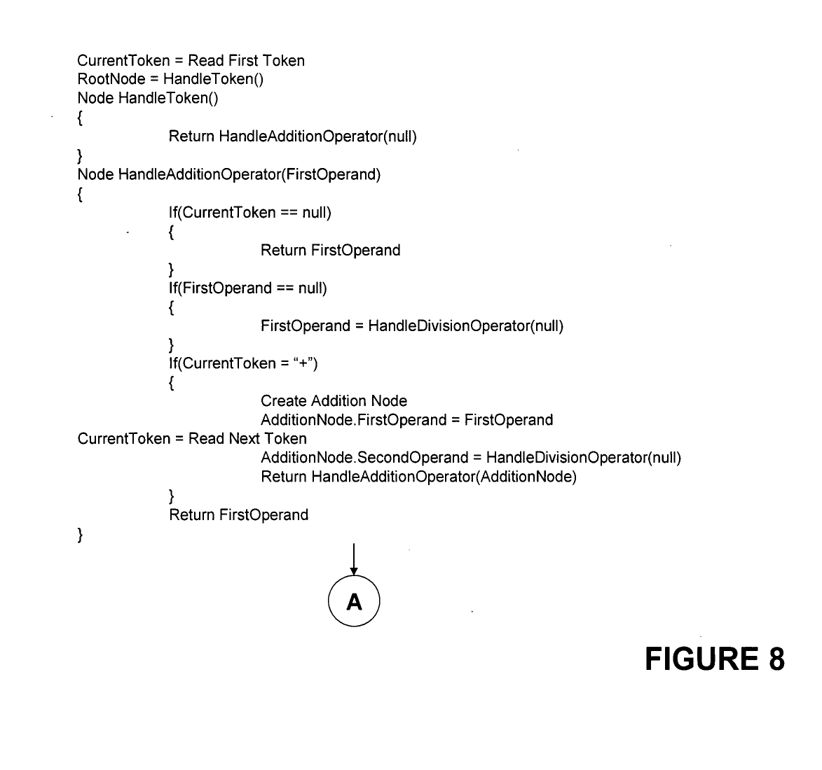

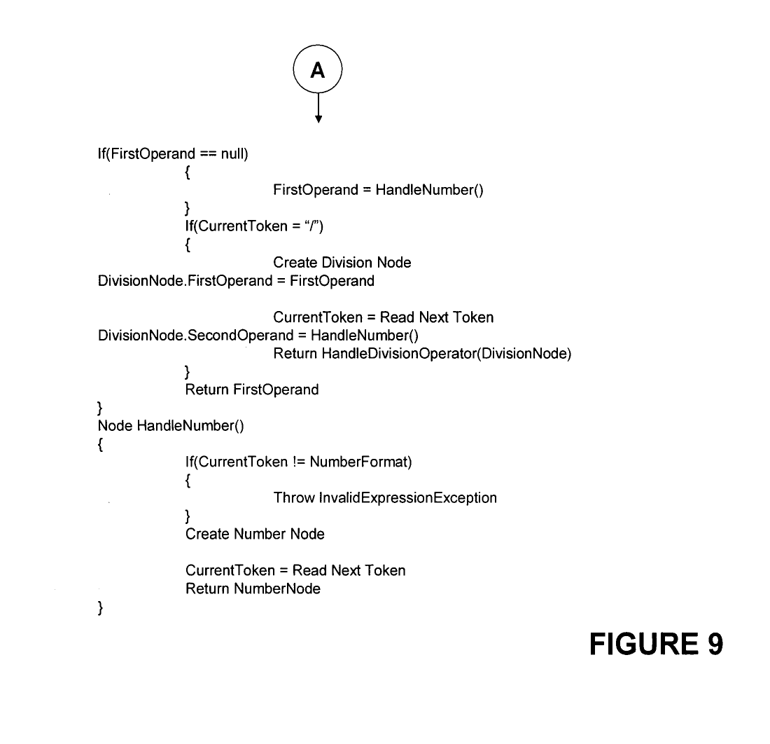

To facilitate an understanding of the parsing process, a simplified example is provided in which the expression “5+4.3/3” is parsed. FIG. 8 and FIG. 9 depict example pseudo code for an example process for parsing an expression. The first value “5” of the expression “5+4.3/3” is read in as the current token. This is implemented by the statement CurrentToken=Read First Token. Next, the HandleToken is called, which calls HandleAdditionOperator with a null parameter. The HandleDivisionOperator method is called. The HandleDivisionOperator method is called because of the null parameter for the HandleAdditionOperator. Because of the null parameter for the HandleDivisionOperator method, the HandleNumber method is called. The HandleNumber method identifies the current token of “5” as a number, creates a new number node, reads the next token (“+”), and returns the number node to HandleDivisionOperator. Within HandleDivisionOperator, the current token of “+” does not match the comparison for “/”, so the number node, which is the value of FirstOperand, is returned to HandleAdditionOperator. Within HandleAdditionOperator, the current token of “+” matches the comparison for “+”, so an AdditionNode is created with the NumberNode as the FirstOperand.

The next token is read, making the current token “4.3”, and HandleDivisionOperator is called with a null parameter to populate AdditionNode.SecondOperand. HandleDivisionOperator calls HandleNumber because of the null parameter. HandleNumber identifies “4.3” as a number, creates a new number node, reads the next token (“/”), and returns the new NumberNode to HandleDivisionOperator. Within HandleDivisionOperator, the current token of “/” matches the comparison for “/”, so a DivisionNode is created with the NumberNode as the FirstOperand. The next token is read, making the current token “3”, and HandleNumber is called to populate DivisionNode.SecondOperand. HandleNumber identifies “3” as a number, creates a new number node, reads the next token (null), and returns the new NumberNode to HandleDivisionOperator. HandleDivisionOperator then calls itself, passing the created DivisionNode as the parameter. This recursive call handles another division operator in the expression, if any. The recursive call to HandleDivisionOperator identifies CurrentToken as null and returns the FirstOperand, which is the DivisionNode, to the HandleDivisionOperator method. HandleDivisionOperator returns the DivisionNode to HandleAddition Operator in the AdditionNode. SecondOperand assignment statement. HandleAdditionOperator calls itself, passing the created AdditionNode as the parameter. This recursive call handles another addition operator in the expression, if any. The recursive call to HandleAdditionOperator identifies CurrentToken as null and returns the FirstOperand, which is the AdditionNode, to the HandleToken method. The HandleToken method returns the resulting node to the assignment statement RootNode=HandleToken( ). The parse tree is now fully constructed, with RootNode as a reference to the top node in the parse tree. The parse tree structure can be represented as shown in FIG. 6.

After an expression has been parsed into a parse tree, the parse tree is evaluated. In an example embodiment, the parse tree is evaluated utilizing a Visitor design pattern. The Visitor design pattern is used during expression evaluation to visit each node in a parse tree to evaluate the result of the expression. The visitor pattern provides for a separation between the structure of the parse tree and the logic that actually performs the evaluation, allowing extensive customization of the types of data that can be processed without needing to make changes to the interfaces of the nodes themselves. The Visitor pattern allows for separation between the structure of a set of objects and the operations (or behaviors) that can be applied to that structure.

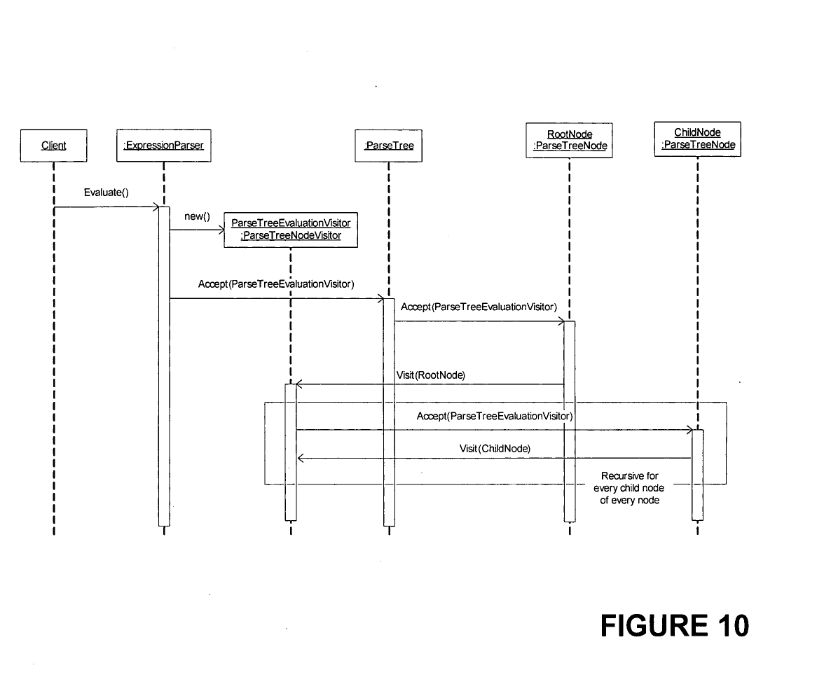

In an example embodiment, a ParseTreeNodeVisitor abstract class is used as a base class for visitors that perform the actual evaluation of a parse tree. (Note: Semantic validation and serialization of parse trees also are performed by visitor classes derived from the ParseTreeNodeVisitor.) The visitor starts visiting the parse tree at the top, or root, node, and drives the visitation process down through the parse tree. FIG. 10 is a sequence flow diagram of an example process for evaluating a parse tree. As shown in FIG. 10, each node in the parse tree is derived from the ParseTreeNode base class and overrides the base class's Accept method. The Accept method accepts a reference to a visitor object and calls that visitor object's Visit method, passing a reference to itself into the Visit method. Example Accept and Visit methods for an addition node (AddNode) are shown below.

```
// Accept method implemented in the AddNode class
public override void Accept(ParseTreeNodeVisitor visitor)
  {
    visitor.Visit(this);
  }
// Visit method implemented in the visitor class
public override void Visit(AddNode node)
  {
    decimal firstOperand = GetDecimalResult(node.FirstOperand);
    decimal secondOperand = GetDecimalResult(node.SecondOperand);
    SetResult(firstOperand + secondOperand);
  }
  // Protected method within the visitor class - this method is not directly
  // part of the visitor pattern, but it is included here for reference.
protected virtual decimal GetDecimalResult(ParseTreeNode node)
  {
    node.Accept(this);
    return this.currentResult.ToDecimal();
  }
```

The AddNode.Accept method receives a reference to a visitor object, and the method directly calls the visitor. Visit method, passing the method a reference to the AddNode object (this). Due to the overloading of the visitor. Visit method, the correct Visit method (the one that accepts an AddNode parameter) is called in the visitor object. This approach ensures that the evaluation of the parse tree is performed from the bottom-up, in accordance with the tree structure built by the parser. The “double dispatching” defined by the Visitor pattern facilitates the separation of the node structure from the actions that can be performed on it. This provides a significant degree of flexibility. For example, the implementation shown above demonstrates how the Visitor pattern can be used to add the two operands of the AddNode object together to obtain a result. Alternatively, the Visit method could have validated that the operands were the right types of objects or it could have serialized the data in the AddNode object in whatever format is desired by the visitor. These different operations can be accomplished without changing the internal structure or external interface of the nodes that comprise the parse tree. As a result, new behaviors can be applied to a parse tree without requiring a change to the parse tree structure or node interfaces.

In an example embodiment, the default evaluation visitor treats null variable values (returned by the variable resolver) as exception cases (i.e., an exception will be thrown). No attempt is made to coerce a null value to a Boolean or number for use as an operand or function parameter. If null values are to be handled differently, the variable resolver performs the coercion before providing the value to the evaluation process. Alternatively, a different treatment of nulls can be accomplished by implementing a custom evaluation visitor.

Customizable aspects of the expression parser/evaluator include data type, number rounding, and number scaling. In an example embodiment, the default evaluation visitor implemented in the parser class library supports treatment of numeric data either as decimal or double types. The default numeric type is decimal, and the type can be changed to double via an overloaded Evaluate method. Custom numeric type handling can be implemented by deriving from the ParseTreeNodeVisitor class, and implementing support for a preferred numeric data type.

The evaluation process in the customizable expression parser/evaluator supports both intermediate and final rounding of numeric data. If enabled, standard arithmetic rounding is used. Standard arithmetic rounding rounds a number up (away from zero) if it is half-way between two numbers, otherwise, it rounds numbers to the nearest number with the specified number of decimal places. In an example embodiment, the following properties on the ExpressionParser class affect rounding. Precision gets or sets the number of fractional digits (or decimal places) that should be preserved in numbers during evaluation. The effect of the Precision property is determined by the Rounding property. Rounding gets or sets the rounding behavior to use when evaluating an expression. The rounding property effects the application of the Precision property.

In an example embodiment, Rounding is an enumeration value that can be set to one of None, Intermediate, Final, or Always. When Rounding is set to None, no rounding is performed for numbers during expression evaluation. When Rounding is set to Intermediate, rounding is performed for all intermediate result numbers during expression evaluation. When Rounding is set to Final, rounding is performed only for the final result of an expression evaluation. When Rounding is set to Always, rounding is performed both on intermediate evaluation results and on the final result.

The evaluation process in the customizable expression parser/evaluator supports both intermediate and final scaling of numeric data. Scaling is the process of adjusting numbers by some factor. For example, the number 1,000,000 could be scaled by a factor of 1,000 (1,000,000/1,000) so that the result is 1,000, and the number represents numbers of thousands rather than numbers of ones. The properties Scale and Scaling on the ExpressionParser class affect scaling. The Scale property gets or sets the scale to which numbers should be adjusted during evaluation. The effect of the Scale property is determined by the Scaling property. The Scaling property gets or sets the scaling behavior to use when evaluating an expression. The Scaling property effects the application of the Scale property. In an example embodiment, the Scaling property is an enumeration value that can be set to one of None, Intermediate, Final, or Always. When the Scaling property is set to None, no scaling is performed for numbers during expression evaluation. When the Scaling property is set to Intermediate, scaling is performed for all intermediate result numbers during expression evaluation. When the Scaling property is set to Final, scaling is performed only for the final result of an expression evaluation. When the Scaling property is set to Always, scaling is performed both on intermediate evaluation results and on the final result.

In an example embodiment, serialization of parse trees is supported using a SerializeParseTree method on the ExpressionParser class. The serialization process for the customizable expression parser/evaluator is implemented using a ParseTreeNodeVisitor subclass that creates a serialized version of the parse tree. The parser class library supports the serialization formats of FormattedXmlString and XrnlString. The FormattedXmlString formats the serialized parse tree as XML, with carriage returns, line breaks, and tabs. The XmlString formats the serialized parse tree as XML, with no carriage returns, line breaks, or tabs. Other serialization formats are supported by creating additional serialization visitors for the format(s) desired. Also, external serialization and deserialization of parse trees can be performed, as long as the ExpressionParser class is provided with a fully reconstituted in-memory parse tree.

In an example embodiment, parse tree deserialization is supported using a DeserializeParseTree method on the ExpressionParser class. Contrary to the serialization process, the deserialization process does not use a Visitor pattern because the objects that make up the parse tree are constructed based on the contents of the serialized data. The default serialization formats supported by the customizable expression parser/evaluator do not contain type information about the node objects used to represent the parts of the source expression in memory. Rather, the deserialization process uses the same node factory process that is used by the parser to generate the correct objects within the in-memory parse tree. This approach avoids dependencies on any specific object version in order to successfully deserialize a parse tree. The parse tree node objects themselves can change as long as the registered factories can successfully create and return them.

The customizable expression parser/evaluator, the customizable expression parser/evaluator is globalized. That is, the customizable expression parser/evaluator can be customized to be implemented in any culture, or environment, of a user. In an example embodiment, the ExpressionParser exposes a CurrentCulture property, allowing consumers to specify the culture for which the customizable expression parser/evaluator should execute. In an example embodiment, the default for the property is the CurrentThread's CurrentCulture. Data type conversions (such as Convert.ToString( )) include a specification of the current culture defined for the parser. The property ExpressionParser.UseCultureAwareNumberFormat controls whether culture specific decimal and grouping separators can be present in numeric data. In an example the default for the property is false, meaning that numbers can not contain grouping separators and can use the period symbol (“.”) as the decimal separator. If the property is set to true, the number format can contain the decimal and grouping separators defined by the CurrentCulture.NumberFormat.NumberDecimalSeparator and CurrentCulture.NumberFormat.NumberGroupSeparator properties, respectively. All internal string comparisons are performed using the Invariant culture (Culturelnfo.InvariantCulture), with case-sensitivity defined by the IgnoreCase property of the ExpressionParser and the Operator objects. All exception messages are located in a resource file within the parser assembly. Additional, culture specific resource files can be included as they are available.

The design patterns used by the class library provide for extensibility in the parsing and evaluation processes used by the customizable expression parser/evaluator. In an example embodiment, to allow the customizable expression parser/evaluator behavior to be modified and extended, the ExpressionParser class is used as a base class for custom parsing scenarios. Many of the behavioral aspects of the customizable expression parser/evaluator can be changed by derived classes by overriding protected “Define” methods. Some examples of the “Define” methods include DefineBinaryOperators( ), SefineEvaluationVisitor( ), DefineNumberRegularExpression( ), and DefineFunctionNodeFactory( ). To further allow the customizable expression parser/evaluator behavior to be modified and extended, raising of events within the class library is accomplished through protected virtual “On” methods which can be overridden by derived classes, allowing derived classes to perform custom behavior internally based on the occurrence of events.

Tokenization is extensible. The customizable expression parser/evaluator can use a custom tokenizer class for breaking up an expression string into component parts. In an example embodiment, to implement a custom tokenizer, a new class that implements the ITokenizer interface is created, a class that derives from ExpressionParser is created, and the protected virtual DefineTokenizer method in the ExpressionParser subclass is overridden so that it returns an instance of the tokenizer class defined when the new class was created.

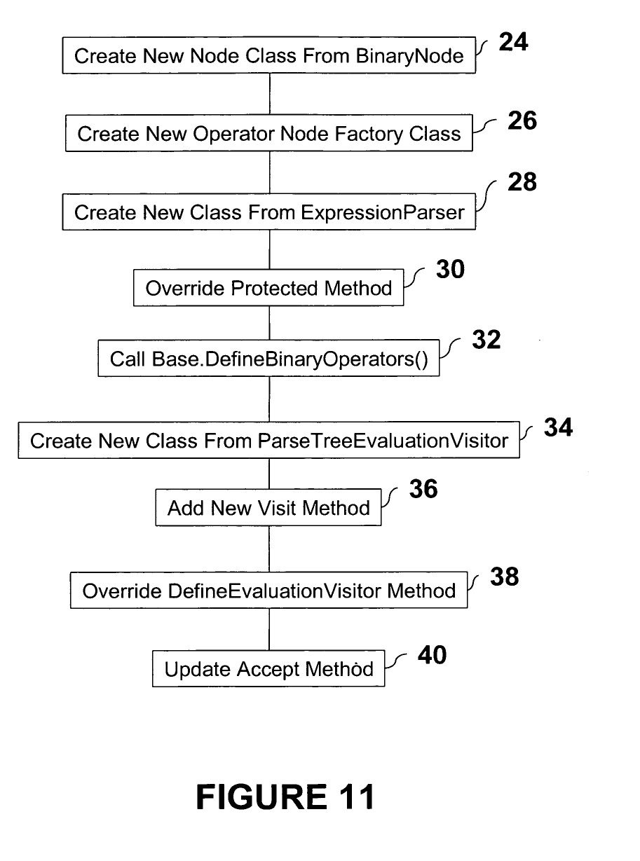

Binary operators are extensible. The customizable expression parser/evaluator supports customization of the binary operators that can be handled by the customizable expression parser/evaluator. FIG. 11 is a flow diagram of an example process for adding a new binary operator. At step 24, a new node class that derives from BinaryNode is created. This new node class is used to represent the custom binary operator within parse trees. For example, if support is desired for an operator that will calculate the result of the first operand raised to the power of the second operand, a new PowerNode class would be created. The PowerNode class would derive from BinaryNode and would implement a constructor that accepts an Operator object and a Token object. Also, the class would override the base Accept method, with a call to the visitor.Visit method (see step 8 for an update that will be made to this Visit method invocation later in the process).

At step 26, a new operator node factory class is created for the PowerNode called PowerNodeFactory. This new class implements the IOperatorNodeFactory interface, which contains one method, GetOperatorNode. The GetOperatorNode method returns a new instance of a PowerNode that has been created for the specified Operator and Token objects. At step 28, a new class that derives from ExpressionParser is created. For this scenario, the class could be called PowerExpressionParser. The protected virtual DefineBinaryOperators method is overridden at step 30. The method is passed a reference to an OperatorCollection collection. Using the Add method of this collection, a new operator definition for the power operator can be added, such as that shown below:

binaryOperators.Add(new Operator(“\hat{ }”, Associativity.Left,
MultiplicativePrecedence, new PowerNodeFactory( ), this.ignoreCase));

The third parameter is the precedence for the operator. Constants are defined for additive, multiplicative, comparison, and equal binary operators, so a user can decide what precedence the user prefers for this new operator. In this example case, MultiplicativePrecedence has been chosen, which will make the operator have the same precedence as multiplication and division. The fourth parameter specifies the node factory that is used to create parse tree nodes when this operator is encountered in expressions. The value for the parameter in this case is a new PowerNodeFactory object.

At step 32, if support for the default binary operators is desired, base.DefineBinaryOperators( ) is called after adding the custom binary operator. At step 34, a new class that derives from ParseTreeEvaluationVisitor is created. For this example scenario, the class is called PowerEvaluationVisitor. At step 36, a new Visit method is added that will handle the PowerNode class. Within the Visit method, the logic to raise the first node for the PowerNode object to the power of the second node is written. An example of this method is:

```
// Visit method implemented in the visitor class
public void Visit(PowerNode node)
  {
    double firstOperand = GetDoubleResult(node.FirstOperand);
    double secondOperand = GetDoubleResult(node.SecondOperand);
    SetResult(Math.Pow(firstOperand, secondOperand));
  }
```

At step 38, the DefineEvaluationVisitor method in the PowerExpressionParser class is overridden, and a new instance of the PowerEvaluationVisitor visitor class as the visitor that should be used to evaluate expressions is returned. At step 40, the Accept method in the PowerNode class is updated so that it will up-cast the supplied visitor object reference to a PowerEvaluationVisitor, allowing a call to the correct Visit method. An example of such a method is:

```
// Accept method implemented in the AddNode class
public override void Accept(ParseTreeNodeVisitor visitor)
    {
        ((PowerEvaluationVisitor)visitor).Visit(this);
    }
```

A serialization visitor subclass can also be defined if the custom node has additional properties/state that are to be maintained across serialization and deserialization. In this case, a deserialization subclass would also be utilized to handle deserialization of this custom state.

Unary operators are extensible. The customizable expression parser/evaluator supports customization of the unary operators that can be handled by the customizable expression parser/evaluator. The steps to add support for a new unary operator are similar to those for adding a new binary operator described above. A difference however, is that the new node class is derived from UnaryNode rather than from BinaryNode. Another difference is that, within the derived ExpressionParser class, the DefineUnaryOperators method is overridden rather than the DefineBinaryOperators method.

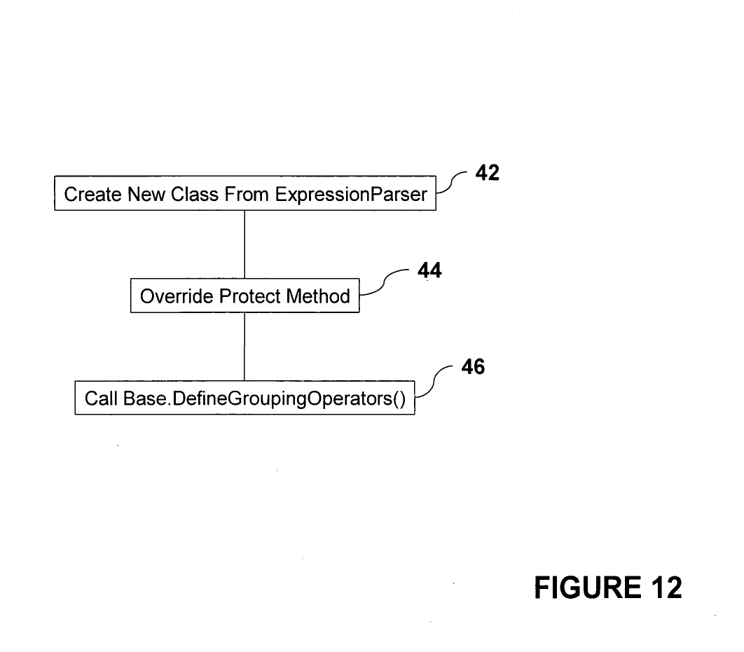

Grouping operators are extensible. The customizable expression parser/evaluator supports customization of the grouping operators that can be handled by the customizable expression parser/evaluator. FIG. 12 is a flow diagram of an example process for adding a new grouping operator. At step 42, a new class is created that derives from ExpressionParser. For this example scenario, the class is called NewGroupExpressionParser. At step 44, the protected virtual DefineGroupingOperators method is overridden. The method is passed a reference to a GroupOperatorCollection collection. Using the Add method of this collection, a new grouping operator definition is added, such as the example definition:

groupingOperators.Add(new GroupOperator(“{“,”}”, this.ignoreCase)).

### At step 46, if support for the default grouping operators is desired, the base DefineGroupingOperators( ) is called after adding the custom grouping operator.

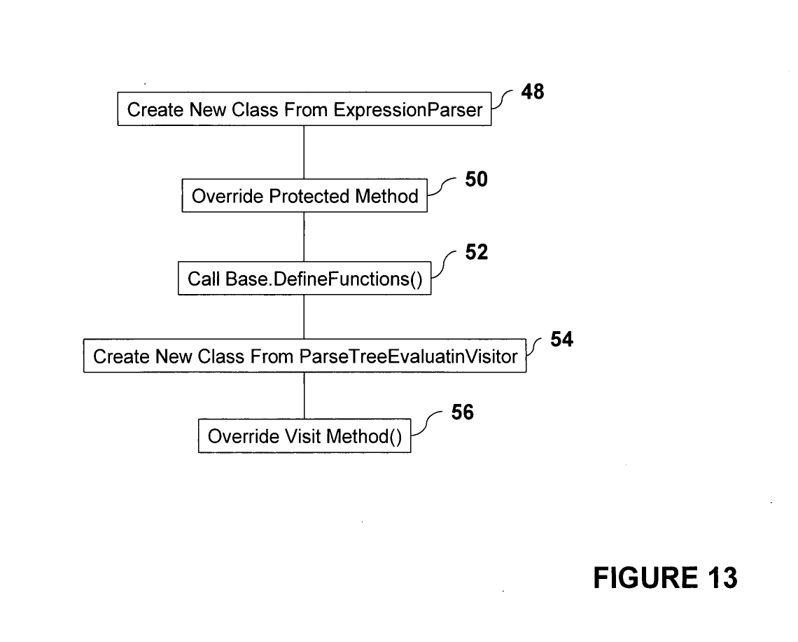

Function format and functions are extensible. The customizable expression parser/evaluator supports customization of the functions that can be handled by the customizable expression parser/evaluator. FIG. 13 is a flow diagram of an example process for adding a new function. For the purposes of this example, assume the new function is called CircleArea and it computes the area of a circle given its radius. At step 48, a new class is created that derives from ExpressionParser. For this example scenario, the class is called CircleAreaExpressionParser. At step 50, the protected virtual DefineFunctions method is overridden. The method is passed a reference to a FunctionFormat object and a FunctionCollection collection. In this example, the default function format is FunctionName(param1, param2). In other embodiments, other function formats can be specified; however, the FunctionName(param1, param2) format is applicable to all functions defined for the customizable expression parser/evaluator, not just the example CircleArea function. Using the Add method of the collection, a new function definition for the CircleArea function is added. An example of which is shown below:

functions.Add(new Function(“CircleArea”, 1));

The second parameter indicates the number of parameters the function requires. In this case, only one parameter is required.

At step 52, if support for the default functions is desired, base.DefineFunctions ( ) is called after adding the custom function. At step 54, a new class is created that derives from ParseTreeEvaluationVisitor. For this example scenario, the class is called CircleAreaEvaluationVisitor. At step 54, within the CircleAreaEvaluationVisitor, the Visit method that accepts a FunctionNode parameter and add support for the CircleArea function is overridden; an example of which is provided below.

```
// Visit method implemented in the visitor class
public override void Visit(FunctionNode node)
{
  // Ensure the correct number of parameters are provided
  if(node.SourceFunction.ParameterCount == node.Parameters.Count)
  {
    string functionName = node.SourceFunction.Name;
    if(this.parserEnvironment.StringsMatch(“CircleArea”,
    functionName))
    {
      double parameter =
          GetDoubleResult(node.Parameters[FirstParameter
          Index]);
      SetResult(Math.PI * Math.Pow(parameter, 2));
    }
    else
    {
      // Call EvaluateFunction if support should
      // be included for default functions. Otherwise,
      // an exception should be thrown because the
      // function is not supported.
      EvaluateFunction(node);
    }
  }
  else
  {
    // The exception message below should be in a resource
    // file, but it is shown here in-line for clarity.
    throw new InvalidOperationException(“Invalid number of parameters
    are defined for function ” + node.SourceFunction.Name);
  }
}
```

Data types are extensible. The customizable expression parser/evaluator supports customization of the data types used during expression evaluation. This customization is accomplished by creating a new class that derives from ParseTreeNodeVisitor and providing an implementation for the nodes using the desired data type(s). Alternatively, a class can be derived from ParseTreeEvaluationVisitor, if it provides the base set of functionality that is desirable in the new visitor. In either case, the new evaluation visitor is defined for use by the parser by creating a new class that derives from ExpressionParser and within the derived class, override the protected virtual DefineEvaluationVisitor method and return a new instance of the custom evaluation visitor.

Complex expressions are extensible. The customizable expression parser/evaluator supports customization of the complex expressions handled during expression parsing and evaluation. The steps to add support for a new custom expression are similar to those for adding a new binary operator described above. A difference is that the new node class is derived from ComplexExpressionNode rather than from BinaryNode. Another difference is that the IComplexExpressionNodeFactory interface is implement in the node factory class rather than the IOperatorNodeFactory interface. Another difference is that, within the derived ExpressionParser class, the DefineComplexExpressions method is overridden rather than the DefineBinaryOperators method, and the Add method of the passed in ComplexExpressionCollection object is used to add the definition for a new ComplexExpression.

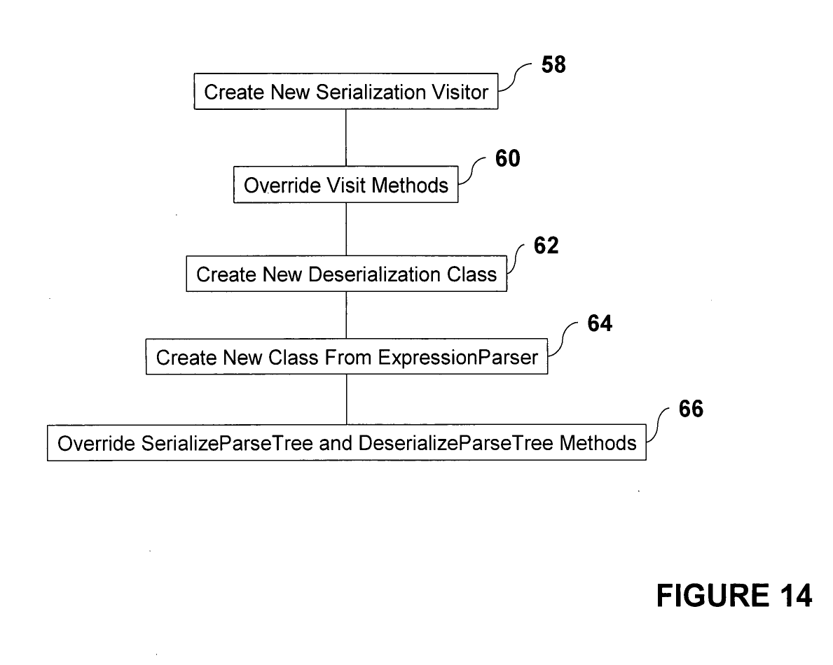

Serialization is extensible. The customizable expression parser/evaluator supports the addition of custom serialization formats. FIG. 14 is a flow diagram of an example process for adding custom serialization formats. At step 58, a new serialization visitor is created that is derived from ParseTreeNodeVisitor. At step 60, within the new visitor class, Visit methods for all of the node types are overridden, and the required logic to create the desired serialization format is implemented. At step 62, a new deserialization class is created that reads the serialization format created at step 60 and creates a fully reconstituted in-memory parse tree. At step 64, a new class is created that derives from ExpressionParser. At step 66, within the derived ExpressionParser class, the SerializeParseTree and DeserializeParseTree methods are overridden with method signatures that accept a different enumeration that specifies the format(s) that are supported in the custom implementation.

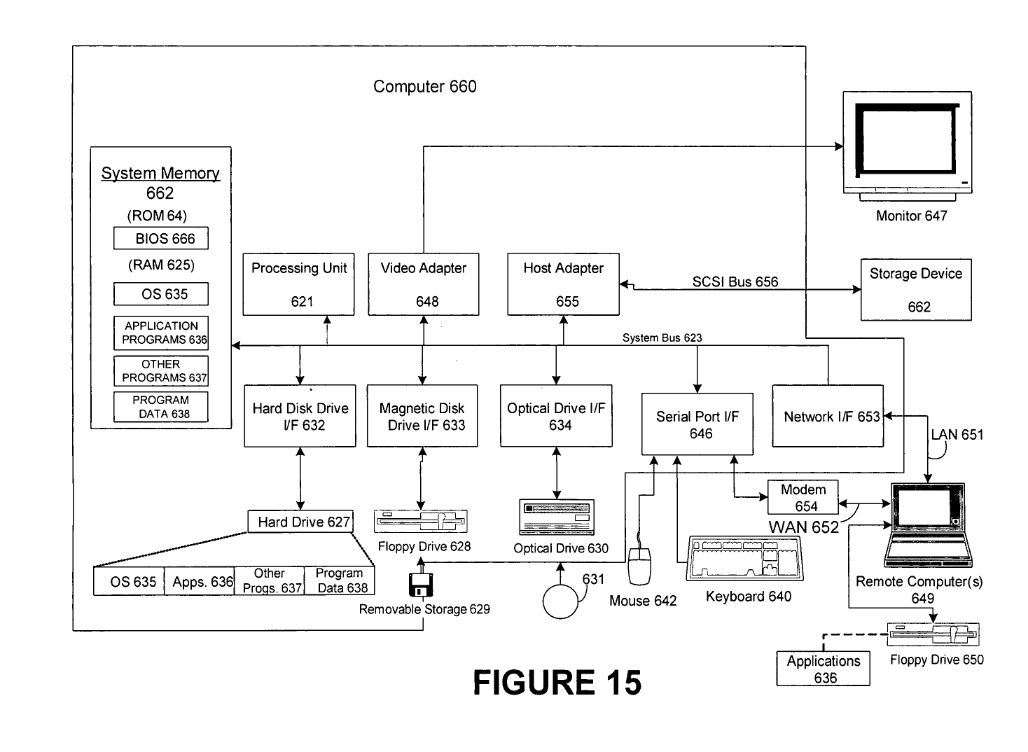

Various embodiments of the customizable expression parser/evaluator are executable on a computing device. FIG. 15 and the following discussion provide a brief general description of a suitable computing environment in which such a computing device can be implemented. Although not required, various aspects of the customizable expression parser/evaluator can be described in the general context of computer executable instructions, such as program modules, being executed by a computer, such as a client workstation or a server. Generally, program modules include routines, programs, objects, components, data structures and the like that perform particular tasks or implement particular abstract data types. Moreover, authorizing software utilizing reputation can be practiced with other computer system configurations, including hand held devices, multi processor systems, microprocessor based or programmable consumer electronics, network PCs, minicomputers, mainframe computers, and the like. Further, the customizable expression parser/evaluator also can be practiced in distributed computing environments where tasks are performed by remote processing devices that are linked through a communications network. In a distributed computing environment, program modules can be located in both local and remote memory storage devices.

A computer system can be roughly divided into three component groups: the hardware component, the hardware/software interface system component, and the applications programs component (also referred to as the “user component” or “software component”). In various embodiments of a computer system the hardware component may comprise the central processing unit (CPU) 621, the memory (both ROM 664 and RAM 625), the basic input/output system (BIOS) 666, and various input/output (I/O) devices such as a keyboard 640, a mouse 642, a monitor 647, and/or a printer (not shown), among other things. The hardware component comprises the basic physical infrastructure for the computer system.

The applications programs component comprises various software programs including but not limited to compilers, database systems, word processors, business programs, videogames, and so forth. Application programs provide the means by which computer resources are utilized to solve problems, provide solutions, and process data for various users (machines, other computer systems, and/or end-users). In an example embodiment, application programs perform the functions associated with the customizable expression parser/evaluator as described above.

The hardware/software interface system component comprises (and, in some embodiments, may solely consist of) an operating system that itself comprises, in most cases, a shell and a kernel. An “operating system” (OS) is a special program that acts as an intermediary between application programs and computer hardware. The hardware/software interface system component may also comprise a virtual machine manager (VMM), a Common Language Runtime (CLR) or its functional equivalent, a Java Virtual Machine (JVM) or its functional equivalent, or other such software components in the place of or in addition to the operating system in a computer system. A purpose of a hardware/software interface system is to provide an environment in which a user can execute application programs.

The hardware/software interface system is generally loaded into a computer system at startup and thereafter manages all of the application programs in the computer system. The application programs interact with the hardware/software interface system by requesting services via an application program interface (API). Some application programs enable end-users to interact with the hardware/software interface system via a user interface such as a command language or a graphical user interface (GUI).

A hardware/software interface system traditionally performs a variety of services for applications. In a multitasking hardware/software interface system where multiple programs may be running at the same time, the hardware/software interface system determines which applications should run in what order and how much time should be allowed for each application before switching to another application for a turn. The hardware/software interface system also manages the sharing of internal memory among multiple applications, and handles input and output to and from attached hardware devices such as hard disks, printers, and dial-up ports. The hardware/software interface system also sends messages to each application (and, in certain case, to the end-user) regarding the status of operations and any errors that may have occurred. The hardware/software interface system can also offload the management of batch jobs (e.g., printing) so that the initiating application is freed from this work and can resume other processing and/or operations. On computers that can provide parallel processing, a hardware/software interface system also manages dividing a program so that it runs on more than one processor at a time.

A hardware/software interface system shell (referred to as a “shell”) is an interactive end-user interface to a hardware/software interface system. (A shell may also be referred to as a “command interpreter” or, in an operating system, as an “operating system shell”). A shell is the outer layer of a hardware/software interface system that is directly accessible by application programs and/or end-users. In contrast to a shell, a kernel is a hardware/software interface system's innermost layer that interacts directly with the hardware components.

As shown in FIG. 15, an exemplary general purpose computing system includes a conventional computing device 660 or the like, including a processing unit 621, a system memory 662, and a system bus 623 that couples various system components including the system memory to the processing unit 621. The system bus 623 may be any of several types of bus structures including a memory bus or memory controller, a peripheral bus, and a local bus using any of a variety of bus architectures. The system memory includes read only memory (ROM) 664 and random access memory (RAM) 625. A basic input/output system 666 (BIOS), containing basic routines that help to transfer information between elements within the computing device 660, such as during start up, is stored in ROM 664. The computing device 660 may further include a hard disk drive 627 for reading from and writing to a hard disk (hard disk not shown), a magnetic disk drive 628 (e.g., floppy drive) for reading from or writing to a removable magnetic disk 629 (e.g., floppy disk, removal storage), and an optical disk drive 630 for reading from or writing to a removable optical disk 631 such as a CD ROM or other optical media. The hard disk drive 627, magnetic disk drive 628, and optical disk drive 630 are connected to the system bus 623 by a hard disk drive interface 632, a magnetic disk drive interface 633, and an optical drive interface 634, respectively. The drives and their associated computer readable media provide non volatile storage of computer readable instructions, data structures, program modules and other data for the computing device 660. Although the exemplary environment described herein employs a hard disk, a removable magnetic disk 629, and a removable optical disk 631, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like may also be used in the exemplary operating environment. Likewise, the exemplary environment may also include many types of monitoring devices such as heat sensors and security or fire alarm systems, and other sources of information.

A number of program modules can be stored on the hard disk, magnetic disk 629, optical disk 631, ROM 664, or RAM 625, including an operating system 635, one or more application programs 636, other program modules 637, and program data 638. A user may enter commands and information into the computing device 660 through input devices such as a keyboard 640 and pointing device 642 (e.g., mouse). Other input devices (not shown) may include a microphone, joystick, game pad, satellite disk, scanner, or the like. These and other input devices are often connected to the processing unit 621 through a serial port interface 646 that is coupled to the system bus, but may be connected by other interfaces, such as a parallel port, game port, or universal serial bus (USB). A monitor 647 or other type of display device is also connected to the system bus 623 via an interface, such as a video adapter 648. In addition to the monitor 647, computing devices typically include other peripheral output devices (not shown), such as speakers and printers. The exemplary environment of FIG. 15 also includes a host adapter 655, Small Computer System Interface (SCSI) bus 656, and an external storage device 662 connected to the SCSI bus 656.

The computing device 660 may operate in a networked environment using logical connections to one or more remote computers, such as a remote computer 649. The remote computer 649 may be another computing device (e.g., personal computer), a server, a router, a network PC, a peer device, or other common network node, and typically includes many or all of the elements described above relative to the computing device 660, although only a memory storage device 650 (floppy drive) has been illustrated in FIG. 15. The logical connections depicted in FIG. 15 include a local area network (LAN) 651 and a wide area network (WAN) 652. Such networking environments are commonplace in offices, enterprise wide computer networks, intranets and the Internet.

When used in a LAN networking environment, the computing device 660 is connected to the LAN 651 through a network interface or adapter 653. When used in a WAN networking environment, the computing device 660 can include a modem 654 or other means for establishing communications over the wide area network 652, such as the Internet. The modem 654, which may be internal or external, is connected to the system bus 623 via the serial port interface 646. In a networked environment, program modules depicted relative to the computing device 660, or portions thereof, may be stored in the remote memory storage device. It will be appreciated that the network connections shown are exemplary and other means of establishing a communications link between the computers may be used.

While it is envisioned that numerous embodiments of the customizable expression parser/evaluator are particularly well-suited for computerized systems, nothing in this document is intended to limit the invention to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

The various techniques described herein can be implemented in connection with hardware or software or, where appropriate, with a combination of both. Thus, the methods and apparatuses for the customizable expression parser/evaluator, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for the customizable expression parser/evaluator.

The program(s) can be implemented in assembly or machine language, if desired. In any case, the language can be a compiled or interpreted language, and combined with hardware implementations. The methods and apparatuses for the customizable expression parser/evaluator also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for the customizable expression parser/evaluator. When implemented on a general-purpose processor, the program code combines with the processor to provide a unique apparatus that operates to invoke the functionality the customizable expression parser/evaluator. Additionally, any storage techniques used in connection with the customizable expression parser/evaluator can invariably be a combination of hardware and software.

While the customizable expression parser/evaluator has been described in connection with the example embodiments of the various figures, it is to be understood that other similar embodiments can be used or modifications and additions can be made to the described embodiments for performing the same functions for the customizable expression parser/evaluator without deviating therefrom. Therefore, the customizable expression parser/evaluator as described herein should not be limited to any single embodiment, but rather should be construed in breadth and scope in accordance with the appended claims.

What is claimed:

1. A processor-implemented method for parsing and evaluating a mathematical expression, the method comprising:
tokenizing, via at least one call to a class library, the mathematical expression into a plurality of tokens indicative of components of the mathematical expression, wherein the class library exposes methods for performing the step of tokenizing;
parsing, via at least one call to the class library, the plurality of tokens to generate a parse tree indicative of a hierarchical structure of the tokens, wherein the class library exposes methods for performing the step of parsing;
evaluating, via at least one call to the class library, the parse tree in accordance with the hierarchical structure, wherein the class library exposes methods for performing the step of evaluating; and
performing at least one of storing and transmitting a result of the evaluation.

2. A method in accordance with claim 1, wherein each of tokenizing, parsing, and evaluating is modifiable without developing a custom software language.

3. A method in accordance with claim 1, wherein each of tokenizing, parsing, and evaluating is modifiable without embedding support for a software language execution environment existing on the processor.

4. A method in accordance with claim 1, wherein the class library is extensible.

5. A method in accordance with claim 4, wherein at least one of the properties of the class library consisting of expression syntax, operators, operations, precedence rules, associativity rules, functions, variable resolution, number precision, number scale, culture awareness, case sensitivity, and data types, is extensible.

6. A method in accordance with claim 1, wherein the class library is programmed in C#.

7. A method in accordance with claim 1, wherein the generated parse tree is capable of being evaluated a plurality of times without regenerating the parse tree.

8. A method in accordance with claim 1, further comprising serializing, via at least one call to the class library, the result of the evaluation, wherein the class library exposes methods for performing the step of serializing.

9. A method in accordance with claim 8, further comprising deserializing, via at least one call to the class library, a result of the serializing, wherein the class library exposes methods for performing the step of deserializing.

10. A computer-readable medium comprising computer-readable instructions for parsing and evaluating a mathematical expression, the computer-readable instructions for:
calling, from a class library, at least one method for tokenizing the mathematical expression into a plurality of tokens indicative of components of the mathematical expression;
calling, from the class library, at least one method for parsing the plurality of tokens to generate a parse tree indicative of a hierarchical structure of the tokens; and
calling, from the class library, at least one method for evaluating the parse tree in accordance with the hierarchical structure.

11. A computer-readable medium in accordance with claim 10, wherein each of tokenizing, parsing, and evaluating is modifiable without developing a custom software language.

12. A computer-readable medium in accordance with claim 10, wherein each of tokenizing, parsing, and evaluating is modifiable without embedding support for a software language execution environment existing on the processor.

13. A computer-readable medium in accordance with claim 10, wherein the class library is extensible.

14. A computer-readable medium in accordance with claim 13, wherein at least one of the properties of the class library consisting of expression syntax, operators, operations, precedence rules, associativity rules, functions, variable resolution, number precision, number scale, culture awareness, case sensitivity, and data types, is extensible.

15. A computer-readable medium in accordance with claim 10, wherein the class library is programmed in C#.

16. A computer-readable medium in accordance with claim 10, wherein the generated parse tree is capable of being evaluated a plurality of times without regenerating the parse tree.

17. A computer-readable medium in accordance with claim 10, the computer-executable instructions further for calling, from the class library, at least one method for serializing the result of the evaluation.

18. A computer-readable medium in accordance with claim 17, the computer-executable instructions further for calling, from the class library, at least one method for deserializing a result of the serializing.
